(19) United States
(12) Patent Application Publication
(10) Pub. No.: US 2015/0088597 A1
(43) Pub. Date: Mar. 26, 2015

(54) METHOD, SYSTEM, AND APPARATUS FOR MANAGING CORPORATE RISK

(71) Applicant: Tailored Solutions and Consulting, Inc., Washington, DC (US)

(72) Inventors: Sean DOHERTY, Silver Spring, MD (US); Mark LOPES, Purcellville, VA (US); Natalie LEHR-LOPEZ, Chevy Chase, MD (US)

(73) Assignee: Tailored Solutions and Consulting, Inc., Washington, DC (US)

(21) Appl. No.: 14/556,910

(22) Filed: Dec. 1, 2014

Related U.S. Application Data
(63) Continuation-in-part of application No. 13/692,614, filed on Dec. 3, 2012.
(60) Provisional application No. 61/566,093, filed on Dec. 2, 2011.

(51) Int. Cl. G06Q 10/06

(52) U.S. Cl. CPC G06Q 10/0635; H04L 63/1433
USPC 705/7.28

(57) ABSTRACT

A method, system, and apparatus for facilitating the process of a corporate risk assessment procedure (which may be identified as an “ESA” or “Enterprise Security Assessment”) are disclosed. A method for data gathering and security assessment may allow security assessors to more readily combine the results of a documentation review process and the results of client interviews, and associate those findings with a broad set of sector-specific and international cyber security standards. This method may include aggregating both sets of data, displaying the aggregated data to the security assessor or another party in a convenient manner, executing functions on the data to transform it into a useful form, and electronically comparing the data to one or more cyber security standards. Data may then be communicated back to a user in the form of an electronic or hard-copy report. A system and apparatus may likewise be configured to perform these steps.

### CROSS-REFERENCE TO RELATED APPLICATION

This application is a continuation-in-part application of U.S. Patent Application No. 2013/0159050, filed on Dec. 3, 2012, entitled “Methods and Systems for Managing Corporate Risk.” This application in turn claims priority from U.S. Provisional Patent Application No. 61/566,093, filed on Dec. 2, 2011. The contents of these applications are incorporated by reference herein in their entirety.

### BACKGROUND

Conventional methods of assessing risks to firms' intellectual capital typically involve ad hoc and opinion-driven processes reliant on expert opinion. These consultant-based approaches, by which a third party is employed to assess policy, governance, technology and market risks, suffer from two fundamental shortcomings. First, they are, as noted, opinion-based. Different consultants, having different individual backgrounds and biases, may render different judgments based on the same data, or may even issue contradictory recommendations. Complicating matters further, consultants may not have access to sufficient data to make sound judgments, as many conventional risk management methods and systems are limited to simple system log analysis; these consultants may be forced to rely in whole or in part on guesswork. This may lead firms to develop a false sense of security when major security problems exist, or conversely may cause firms to spend time and effort trying to patch holes that aren't there or aren't as significant as thought.

Second, consultant-based methods are generally not scalable. For typical firms, the amount of data to be analyzed may increase over time, and the cost of consulting resources generally increases at a faster rate than this. The costs and complexity attendant to traditional systems designed to protect this data may likewise increase at a faster rate, particularly as resulting geographic footprints and external partnerships increase. The discrepancies in rates of increase between the amount of data needed to be analyzed and the cost and complexity of analysis exist for several reasons. First, the ability of the human mind to process and identify patterns in large volumes of information of varying kinds is limited, such that an increase in data may result in a greater increase in the requisite number of consultants employed to study it. Even conventional specialized software tools designed to assist consultants are not designed to account for the ever-increasing scale and interdependencies between data from different parts of a firm. As a result, even the most expert and experienced consultants are forced to render impressionistic judgments that do not reflect the totality of available data. Second, the pool of qualified and capable consultants with the requisite experience to analyze disparate sets of information is small, such that as data grows and demand begins to outstrip supply, the latter becomes more costly. These factors combine to render large-scale comprehensive risk management engagements typically very expensive and available only to the largest firms.

### SUMMARY

A method, system, and apparatus for facilitating the process of a corporate risk assessment procedure (which may be identified as an “ESA” or “Enterprise Security Assessment”) are disclosed. A method for data gathering and security assessment may allow security assessors to more readily combine the results of a documentation review process and the results of client interviews, and associate those findings with a broad set of sector-specific and international cyber security standards. This method may include aggregating both sets of data, displaying the aggregated data to the security assessor or another party in a convenient manner, executing functions on the data to transform it into a useful form. The data may be communicated to an assessment server, where it may be analyzed and subsequently communicated back to the assessor or a client.

Likewise, a system and apparatus may be adapted to perform the steps of combining the results of a documentation review process and the results of client interviews, displaying the aggregated data to the security assessor or another party in a convenient manner, communicating the data to an assessment server for analysis and subsequent communication back the assessor or a client in an electronic or hard-copy report.

### BRIEF DESCRIPTION OF THE DRAWINGS

Advantages of embodiments of the present invention will be apparent from the following detailed description of the exemplary embodiments, which are illustrated by way of example and not limitation, and in which like references indicate similar elements. The following detailed description should be considered in conjunction with the accompanying figures in which:

FIG. 1 illustrates an exemplary embodiment of a computer system.

FIG. 2 illustrates an exemplary computer-implemented method of identifying corporate risk.

FIG. 3 is an exemplary three-dimensional diagram showing a data security incident assessment.

FIG. 4 is an exemplary diagram showing intellectual capital risk that stem from a variety of sources in an external business relationships threat vector.

FIG. 5 illustrates an exemplary embodiment of a Web interface that may accompany a system for managing corporate risk.

FIG. 6 illustrates an exemplary embodiment of a Web interface that may accompany a system for managing corporate risk.

FIG. 7 illustrates an exemplary embodiment of a Web interface that may accompany a system for managing corporate risk.

FIG. 7A illustrates an exemplary embodiment of a Web interface that may accompany a system for managing corporate risk.

FIG. 8 illustrates an exemplary embodiment of a Web interface that may accompany a system for managing corporate risk.

FIG. 8A illustrates an exemplary embodiment of a Web interface that may accompany a system for managing corporate risk.

FIG. 8B illustrates an exemplary embodiment of a Web interface that may accompany a system for managing corporate risk.

FIG. 8C illustrates an exemplary embodiment of a Web interface that may accompany a system for managing corporate risk.

FIG. 9 illustrates an exemplary embodiment of a Web interface that may accompany a system for managing corporate risk.

FIG. 10 illustrates an exemplary embodiment of a Web interface that may accompany a system for managing corporate risk.

FIG. 10A illustrates an exemplary embodiment of a Web interface that may accompany a system for managing corporate risk.

FIG. 10B illustrates an exemplary embodiment of a Web interface that may accompany a system for managing corporate risk.

FIG. 10C illustrates an exemplary embodiment of a Web interface that may accompany a system for managing corporate risk.

FIG. 11 illustrates an exemplary embodiment of a Web interface that may accompany a system for managing corporate risk.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

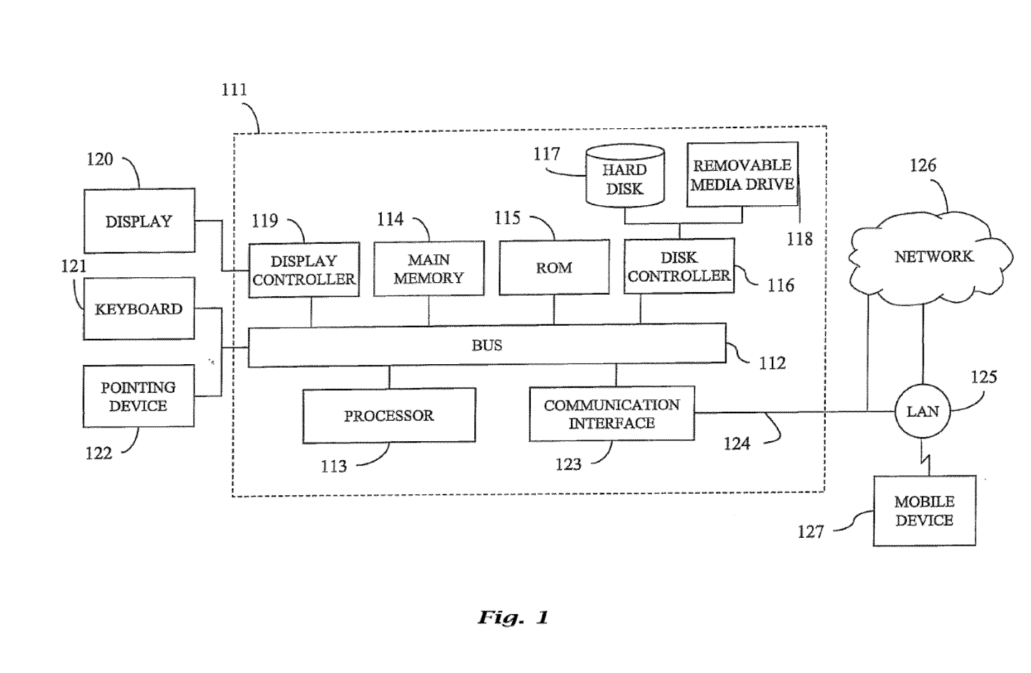

Generally referring to FIGS. 1-4, a method, system, and apparatus for managing corporate risk may be described. Corporate risk may arise, for example, from activities by insiders or outsiders, on site or while mobile, which may result in the loss of intellectual capital in enterprises. In assessing and prioritizing corporate risk, embodiments disclosed herein may utilize a multitude of variables, including, but not limited to, external factors, key valuation drivers, quantified internal systems data, and operating environment. Utilizing these variables may help develop a value-driven risk profile, which may allow companies to prioritize resources for risk mitigation. For example, the category of “external factors” may include elements external to the organization but which may directly impact or affect the organization or which may create a risk for the organization, and may include partnership arrangements with other firms, joint ventures, competitors, and third-party vendors that have access to some client data and/or systems. The category of “key valuation drivers” may include those aspects of an organization's asset or assets that can be used to determine an overall cost valuation of an asset and potential impact to the business operations or brand image when compromised. “Internal systems data” may include any data that resides on a client's internal system or infrastructure, such as files shared on the company network. Finally, an “operating environment” may include any combination of social, economic, and political factors that can affect the activities of an organization; for example, variables corresponding to this category may be used to quantify information about the company culture.

Additionally, any number of factors may be utilized to generate a security risk assessment. For example, the criticality of an asset (that is, the risk that a high cost will be associated with failure of that asset) and the asset's overall importance to the organization's strategic goals and objectives may be evaluated. An asset's exposure to risk may also be studied. Evaluation of an asset's exposure to risk may take into account, for example, the degree of exposure an asset has to people, processes and practice, the degree of exposure to network infrastructure, adversarial intent, and capability and frequency of exposure. Controls and countermeasures that an organization has, including a measure of a method's adequacy for risk mitigation, can be further assessed. Severity or an impact to an asset can be assessed to determine the magnitude of impact that any vulnerability may have to an asset. Additionally, a cost valuation of an asset or a plurality of assets may be made, and may be used in generating the security risk assessment or may be presented on its own. The cost valuation can assess the financial impact to an organization's overall valuation should the asset or assets be compromised.

FIG. 1 illustrates a computer system 111 upon which an embodiment of the present invention may be implemented. In some embodiments, the computer system may be implemented in a tablet device configuration, as would be understood by a person having ordinary skill in the art. The computer system 111 may include a bus 112 or other communication mechanism for communicating information, and a processor 113 coupled with the bus 112 for processing the information. The computer system 111 also may include a main memory 114, such as a random access memory (RAM) or other dynamic storage device (e.g., dynamic RAM (DRAM), static RAM (SRAM), and/or synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 may further include a read only memory (ROM) 115 or other static storage device (e.g., programmable ROM (PROM), erasable PROM (EPROM), and/or electrically erasable PROM (EEPROM)) coupled to the bus 112 for storing static information and instructions for the processor 113.

The computer system 111 may also include a disk controller 116 coupled to the bus 112 to control one or more storage devices for storing information and instructions, such as a magnetic hard disk 117, and a removable media drive 118 (e.g., a floppy disk drive, flash memory drive, read-only compact disc drive, read/write compact disc drive, compact disc jukebox, tape drive, and/or a removable magneto-optical drive). The storage devices may be added to the computer system 111 using an appropriate device interface, including, for example, a small computer system interface (SCSI), integrated device electronics (IDE), enhanced-IDE (E-IDE), direct memory access (DMA), ultra-DMA, a serial port connection, a parallel port connection, USB, IEEE 1394 (FireWire), Bluetooth, Wi-Fi, or any other type of connection or interface known in the art.

The computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system may include input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 may perform a portion or all of the processing steps of exemplary embodiments of the invention in response to the processor 113 executing one or more sequences of one or more instructions contained in a memory, such as the main memory 114. Such instructions may be read into the main memory 114 from another computer-readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 may include at least one computer-readable medium or memory for holding instructions programmed according to the teachings of exemplary embodiments of the invention and for containing data structures, tables, records, or other data described herein. Examples of computer-readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer-readable media, exemplary embodiments of the present invention may include software for controlling the computer system 111, for driving a device or devices for implementing exemplary embodiments of the invention, and for enabling the computer system 111 to interact with a human user. Such software may include, but is not limited to, device drivers, operating systems, development tools, and applications software. Such computer-readable media may further include the computer program product of exemplary embodiments of the present invention for performing all or a portion (if processing is distributed) of the processing performed in implementing exemplary embodiments of the invention.

The computer code devices of exemplary embodiments of the present invention may be any interpretable or executable code mechanism, including but not limited to scripts, interpretable programs, dynamic link libraries (DLLs), Java classes, and complete executable programs. Moreover, parts of the processing of exemplary embodiments of the present invention may be distributed, if desired; this may result in better performance, reliability, and/or cost.

The term “computer-readable medium” as used herein refers to any medium that may participate in providing instructions to the processor 113 for execution. A computer-readable medium may take many forms, including but not limited to, non-volatile media, volatile media, and transmission media. Non-volatile media includes, for example, optical disks, magnetic disks, and magneto-optical disks, such as the hard disk 117 or the removable media drive 118. Volatile media may include dynamic memory, such as the main memory 114. Transmission media may include coaxial cables, copper wire and fiber optics, including the wires that make up the bus 112. Transmission media also may also take the form of acoustic or light waves, such as those generated during radio wave and infrared data communications. Transmission may be accomplished using, for example, a serial port connection, a parallel port connection, USB, IEEE 1394 (FireWire), Bluetooth, Wi-Fi, or any other type of connection or interface known in the art.

Various forms of computer-readable media may be involved in carrying out one or more sequences of one or more instructions to processor 113 for execution. For example, the instructions may initially be carried on a magnetic disk of a remote computer. The remote computer can load the instructions for implementing all or a portion of exemplary embodiments of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 may carry the data to the main memory 114, from which the processor 113 may retrieve and execute the instructions. The instructions received by the main memory 114 may optionally be stored on storage device 117 or 118 either before or after execution by processor 113.

The computer system 111 may also include a communication interface 123 coupled to the bus 112. The communication interface 123 may provide a two-way data communication coupling to a network link 124 that may be connected to, for example, a local area network (LAN) 125, or to another communications network 126 such as the Internet. For example, the communication interface 123 may be a network interface card to attach to any packet-switched LAN. As another example, the communication interface 123 may be an asymmetrical digital subscriber line (ADSL) card, an integrated services digital network (ISDN) card or a modem to provide a data communication connection to a corresponding type of communications line. Alternatively, a wireless link, such as, for example, a Wi-Fi or Bluetooth connection, may also be implemented. In any such implementation, the communication interface 123 may send and receive electrical, electromagnetic or optical signals that may carry digital data streams representing various types of information.

The network link 124 typically may provide data communication through one or more networks to other data devices. For example, the network link 124 may provide a connection to another computer or remotely located presentation device through a local network 125 (e.g., a LAN) or through equipment operated by a service provider, which may provide communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, may be one of the exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. Again, in preferred embodiments, the LAN communications network 125 and the communications network 126 may both use electrical, electromagnetic or optical signals that carry digital data streams; likewise, according to these embodiments, the signals through the various networks and the signals on the network link 124 and through the communication interface 123, which carry the digital data to and from the system 111, may be one of the exemplary forms of carrier waves transporting the information. The processor system 111 can transmit notifications and receive data, including program code, through the network(s), the network link 124 and the communication interface 123.

Other aspects of exemplary embodiments of the invention may include data transmission and Internet-related activities. See Preston Gralla, How the Internet Works, Ziff-Davis Press (1996), which is hereby incorporated by reference into this patent application. Still other aspects of exemplary embodiments of the invention may utilize wireless data transmission, such as those described in U.S. Pat. Nos. 6,456,645, 5,818,328 and/or 6,208,445, all of which are hereby incorporated by reference into this patent application. In still other aspects, data may be stored or acquired from any source of location, including cloud architecture.

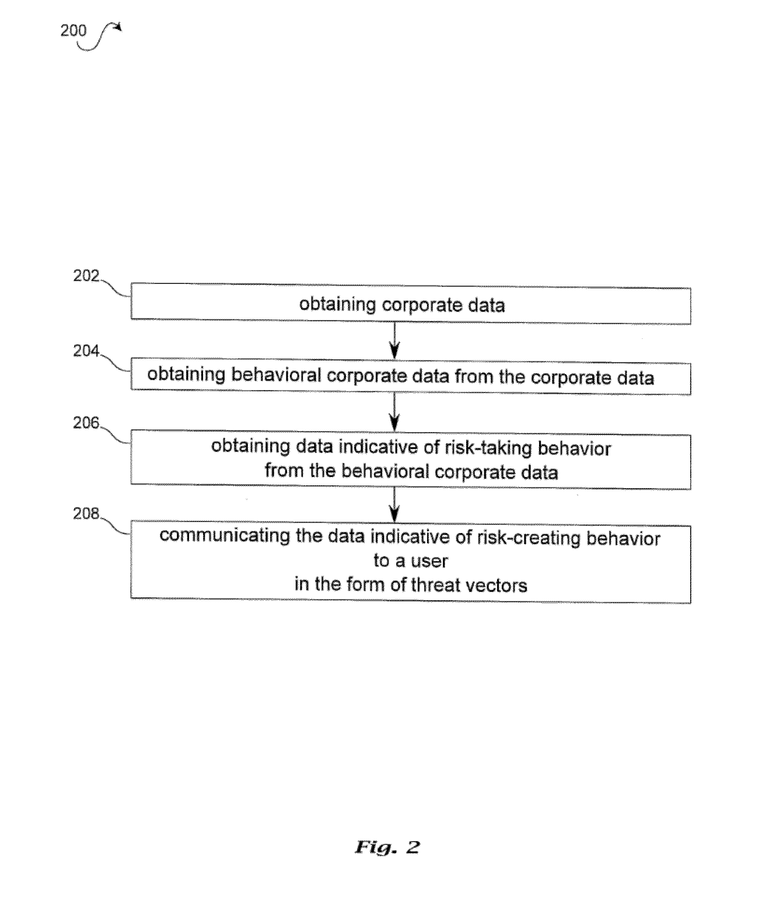

FIG. 2 shows an exemplary computer-implemented method 200 of identifying corporate risk, which may include obtaining corporate data at step 202, obtaining behavioral corporate data from the corporate data at step 204, obtaining data indicative of risk-creating behavior from the behavioral corporate data at step 206, and communicating the data indicative of risk-creating behavior to a user in the form of threat vectors at step 208. Risks to corporate valuation may stem from data about the interactions among, for example, operations, business processes, governance policies, technology systems and relationships. Data may be obtained on or from computer-readable media, from cloud architecture, or from any other source known or desired.

At step 202, corporate data may be obtained by computer-readable media. Corporate data may be internal data generated by existing corporate business processes and technology systems, may be external data from external data sources, or may be some combination of the two. This data may then be quantified to facilitate its evaluation; this may include, for example, generating baseline risk values based on this data. This data may be present in a limited number of sources, for example a specific client report, or may be an aggregation of a larger number of sources; likewise, data may be of a specific data type or multiple data types. For example, external data may include information derived from publically available sources or data stores, subscription-based sources or data stores, or proprietary joint venture or partner sources or data stores. Corporate data may potentially be collected (in this and other steps) from, for example, any available client data, external data sources (including, but not limited to, internet protocol data), news media results, and any other desired information that may be pertinent or relevant to an over risk ecosystem evaluation of a client. Then, in some exemplary embodiments, these different sets of data may be analyzed to provide various forms of data visualization graphics, and may be utilized in the generation of reports detailing various risks that an entity being analyzed may face.

At step 204, behavioral corporate data may be obtained from the corporate data. Behavioral corporate data may include data regarding, for example, behaviors that occur in the course of business; this may include the behaviors of employees, suppliers, customers, or partners, or their mutual interactions. For example, the data may include behavioral data of employees interacting with suppliers, suppliers with customers, or customers with partners. Behavioral corporate data may include event data described by categorical variables.

Categorical variables may include, for example, actors, actions, and attendant characteristics. An event may be a singular action or a series of related actions taken by one or several actors. Actors may include, for example, staff employees, joint venture partners, or third-party vendors. An event may include, for example, an employee downloading data from a network, an employee using an RFID badge, or an outside party applying for a position within a firm.

Categorical variables may have characteristics, and what characteristics are present may vary depending on the type of categorical variable. For example, a categorical variable corresponding to an “employee” actor may have characteristics relevant to an employee or the security risk that may be associated with the employee; these characteristics may include the employee's tenure, their job title, or their gender. A categorical variable corresponding to a “download” event may instead have characteristics like the time of day that the download took place, the file size of the download, and the requesting IP address.

At step 206, data indicative of risk-creating behavior may be obtained from the behavioral corporate data by evaluating the corporate data against a knowledge base of characteristic risk-creating behavior. Such an evaluation of corporate data may include any of a variety of steps. For example, various activities of the organization can be examined as they relate to the movement of data. Further, established policies and procedures, as well as what the organization considers normal, typical or routine business operations or practices may also be studied. These policies and procedures can include, for example, employee activities, partnership engagements, joint venture relationships, collaboration with vendors and other outside sources. After such items are interpreted, a baseline may be established and an awareness and understanding of how an organization operates, the environment in which the organization conducts business and the risk tolerance of the organization may be determined. Then, based on that interpretation and analysis, deviations from the baseline may be more easily and efficiently identified. Potential risks may further be assessed, enabling the organization to be more quickly notified of them and allowing it to take action to mitigate any potential or real risks.

An event or a series of events in time may be identified as risk-creating behavior. Behavioral corporate data may present corporate risk if, when evaluated against the knowledge-base of characteristic risk-creating behavior, its state or its progression in time conforms to certain states or time patterns indicative of activity that has the potential of compromising the intellectual capital of a firm, to the detriment of the firm's competitive advantage. Such a risk-creating behavior might include, for example, allowing a third party vendor independent access to a firm network. Risk-creating behavior may also include lack of activity that has the potential of compromising the intellectual capital of a firm; for example, such a risk-creating behavior might include a failure on the part of the firm's security department to properly cancel employee RFID badges that have been lost, or a failure to do so quickly.

At step 208, the data indicative of risk-creating behavior may be communicated to a user in the form of threat vectors. Data indicative of risk-creating behavior may be represented by a multi-dimensional threat vector, adapted to be displayed on a multi-dimensional graphical representation.

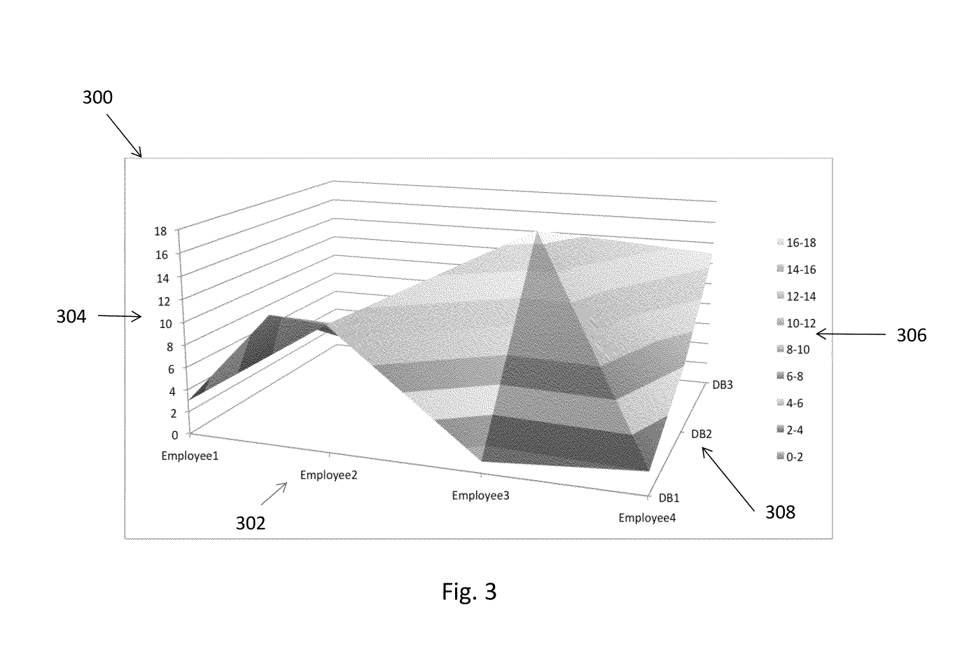

Referring now to exemplary FIG. 3, a graph 300 may be provided to show a threat vector. A first axis 302 of the graph 300 may provide information pertaining to the source of the threat, namely whether a threat is internal or external. A threat may be classified as internal if it originated from firm employees, and may be classified as external if it originated from non-employees. For example, an internal threat may include a threat from a design engineer permitted to use a personal flash drive on a company computer containing valuable engineering data, while an external threat may include a threat stemming from joint venture partners or suppliers' access to privileged information, through local or remote access to employees. Further, different classifications may be used as necessary; for example, a firm that employs volunteers or temporary workers that have not been vetted to the same extent as other firm employees may classify those workers as either internal or external, or may employ a third intermediate classification for those parties. In this exemplary embodiment, the first axis 302 may be employees of an organization.

A second axis 304 of the graph 300 may provide information pertaining to the nature of the threat, namely whether a threat is physical or virtual. Physical threats may relate to direct, proximity-based access to people, facilities or infrastructure, while virtual threats may relate to the use of non-physical, remote access, such as, for example, through IT networks. For example, a physical threat may include a threat from a vendor employee with unmanaged access to client facilities, or a threat from a contract maintenance technician that services corporate communications infrastructure. A virtual threat may include a threat from a partner firm employee who, by virtue of working at a joint venture, is granted IT permissions that mirror client employees, or a threat from a former employee whose IT access permissions are not terminated upon his or her departure from a firm. Threats that are not clearly physical or virtual may be classified as one or the other, or under an independent category.

A third axis 306 of a graph 300 may provide information pertaining to the potential effect of the threat, namely whether a threat is categorized as being primarily a threat to innovation, execution or reputation. A threat to innovation may be one that is likely to affect future earnings, while a threat to execution may affect current earnings and a threat to reputation may affect value added. For example, a vulnerability in a firm's research and development facility may be categorized as a threat to the firm's innovation, and thus to its future earnings. An otherwise-identical vulnerability in a manufacturing plant or in an outside advertising agency that the firm has contracted to build their reputation may be categorized as a threat to the firm's current earnings (i.e. a firm's execution capability), or to its brand equity and value created (i.e. a firm's reputation). Threats that could be classified as more than one of the categories above, for example a vulnerability that allows access to both the manufacturing plant and the research & development facility of the above example, may be classified as any of the categories or as an alternative category.

Additional axes or indicators, such as 308 on graph 300 may be incorporated into a multi-dimensional graphical representation of threat vectors, as needed to adapt to a dynamic and rapidly changing business environment. For example, an additional axis 308 could include a vector indicating how a threat could best be addressed, or could include an approximation of how much it would cost to fix the threat.

One-dimensional, two-dimensional or three-dimensional projections of a multi-dimensional graphical representation may be generated, as needed for different applications, and as possible when given technological constraints. A three-dimensional model may be suitable for media-rich environments that allow the model to be rotated in real time to facilitate nuanced communication of a firm's current risk posture as a function of all threat vectors, as well as a view of the firm's risk posture over time.

Exemplary FIG. 3 provides one such three-dimensional model. In such an example, both qualitative and quantitative risk assessment tools may be utilized to collect various requests to provide a baseline for the organization or be utilized in compliance or auditing, as desired. Such tools may include, but are not limited to, surveys, risk rating scales, automated log analysis tools, and the like. Outputs from different tools may be utilized in the generation of a risk metric, which are then assigned to one or more of a number of security domains. Such domains can include, but are not limited to, physical security, data security, people, internal business process, external business operations, financial data, travel, and incident response. Such exemplary security domains may then be utilized to quickly and efficiently assess where more significant risk may be present.

According to an exemplary embodiment, this baseline data may be compared with the day-to-day practices of a firm, and any deviations from the baseline data in the day-to-day practices may be flagged for further review. Deviations may include a change, rate of change, source of change referenced, or another change in the day-to-day practice data. For example, a baseline may be established where a normal amount of download activity from a predetermined database is five downloads per day. If, after a baseline is established, the downloading behavior of an employee from this database becomes unusually high, beyond what is considered a “normal” or acceptable level from the baseline, this may be flagged or otherwise identified.

The baseline computation may also include other factors. According to another exemplary embodiment, a baseline of five downloads per day may be established, with the understanding that most members of the organization do not begin downloading data until they have worked on a specific matter for about two months. Then, if it is determined that a long term (i.e. longer than two months) employee begins to consistently, routinely or singularly, begin downloading more than 5 times during a given time period, or if a new (i.e. less than two months' tenure) employee begins downloading any data in a given time period, it can be quickly and efficiently determined that this activity varies from the baseline as these would be interpreted as deviations from the baseline. Then, any of a change, rate of change (for example percentage of overall download volume in this example), and source of change (either a change in the employee or a change in the system, data, or database being accessed by the employee) can be monitored or utilized to assess and determine potential risks to the organization, the organization's infrastructure, and the organization's property.

With respect to exemplary FIG. 3, the first axis 302 may be utilized to show employees and risk-related factors may be shown on the other axes. In this example, four employees may be assessed. The second axis 304 can be representative with the amount of time an employee has worked on a certain matter. Per the above example, when an employee has been working on a matter for less than two months, the baseline data may suggest that that employee should not have any downloads from the databases 308 (DB1, DB2, DB3). The third axis 306 may show the amount of downloads, and from which location, that an employee made during a specified time period.

Thus, from this example, if the baseline is known to be five downloads per day, each of the employees' behaviors and actions can be analyzed to determine which employee deviates from the baseline, where the deviations are occurring and when the deviations occur. This data can then be utilized to determine which, if any, parties are creating risk for the organization.

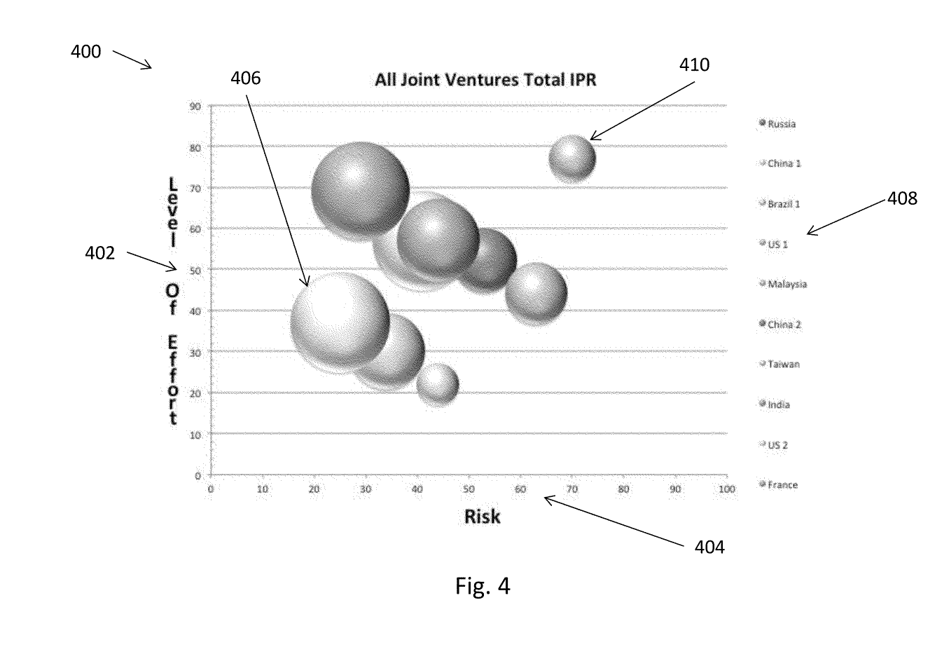

Exemplary FIG. 4 is a graphical diagram 400 showing a composite view of intellectual capital risk that may stem from risk-creating behaviors, events or actors in an external business relationships threat vector. Such an exemplary external business relationship could be a joint venture. The exemplary x-axis 402 may show risk exposure of a client's critical assets in the external business relationship. Such assets may include, but are not limited to, people, programs, physical or virtual access to data or information, legal agreements, and the like. The y-axis 404 can illustrate the anticipated level of effort that may be appropriate to remedy any identified risks. This representation may further include an emphasis on those items that may have the greatest possible return on investment for expenditure in enterprise security; attention may be called to these items by, for example, highlighting. This can further enable an alignment of risk reduction investments with business strategies and priorities.

Still referring to exemplary FIG. 4, the size or weight of a bubble 406 may be related to cost valuation of underlying assets and the sensitivity of the assets to risk-creating behaviors, events or actors. Additionally, in some exemplary embodiments, such as for certain distributed enterprise clients, bubbles, such as bubbles 406 and 410, may be shaded, colored or otherwise depicted in an individual fashion in order to show specific locations that may present a greater security risk from external partnerships.

In the example shown in FIG. 4, the bubble 406 may have a moderate level of effort needed for a low level of risk for a very significant asset cost valuation. As indicated by key 408, bubble 406 may be associated with a first joint venture with a partner from the U.S. Alternatively, bubble 410 may reflect a higher level of effort to achieve only a moderate level of risk for a less significant asset cost valuation. As shown in key 408, bubble 410 may be associated with a joint venture with a partner from Brazil.

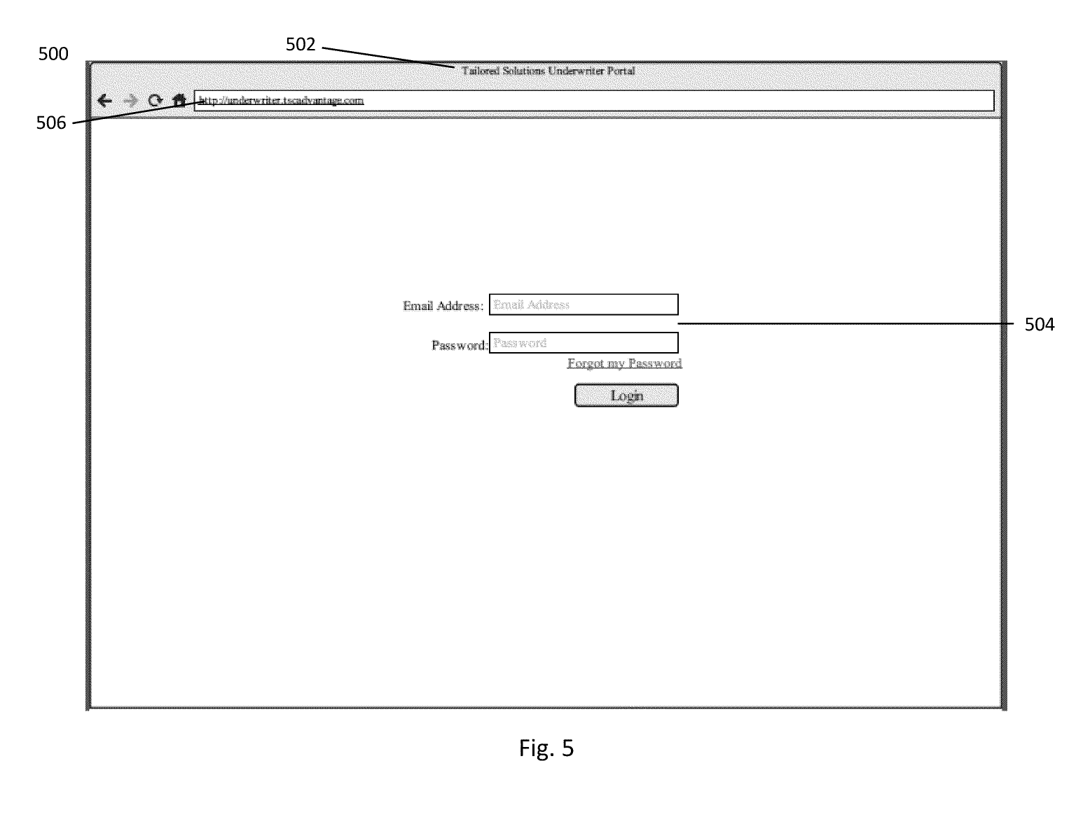

Referring generally to FIGS. 5-11, a system may be used to provide this functionality to the end users or to other parties, and to facilitate the data gathering and assessment phases for a security assessment procedure (which may alternatively be identified as an “ESA,” short for “Enterprise Security Assessment”). Such a system may integrate the documentation review and the interview processes generally performed by security assessors, which may ensure that security assessors have more convenient and comprehensive access to pertinent security-related information. Documentation review may include review of pertinent documents and documented firm data. For example, documented employee data, network data, and other data as would be understood by a person of ordinary skill in the art. The service may also be able to filter the data; for example, it may be able to identify the top sources of risk for an assessee, or may be able to associate the assessor's findings with a broad set of sector-specific, local, or international security standards. According to an alternative embodiment, an offline service or a service on a more restricted network may have the same functionality.

Users of the service may access it via, for example, a portal accessible through an internet browser, or via a software application for a computer, mobile device, or tablet. Different portals may be available for different users, depending on the needs of and access levels of those users; for example, there might be separate portals for underwriters and consultants, for the client and/or the client's agents, for the client's employees, and for administrators of the assessment service. (For example, one portal might be available at the domain underwriter.tscadvantage.com, and another might have the domain client.tscadvantage.com.) Any other groups may also have a portal for their use. Alternatively, a user may be able to log into a generic portal; the software may then tailor the site to that user's anticipated needs and access level. (For example, an underwriter, Bob, who logs in through the generic portal may be redirected to the underwriters' page. Another party who logs into the system may be redirected to the clients' page or the administrator page.) Access to these portals may be controlled by a username and password, restricted to particular computers or other electronic devices, or controlled as desired. Usernames may, for example, be linked to an email address; according to one exemplary embodiment, a user may use their email address as their username, and the service may be configured to send activation emails to users in order to activate their account. This may help to ensure that the user actually has access to that email address, and may allow account information to be recovered by the user as necessary. In some alternative exemplary embodiments, an assessment firm may issue login information to a user upon commencement of an assessment.

Different views and/or different information may be available to each potential user. For example, the client portal may have a section where the client may answer various questions pertaining to the client's security procedures; a portal available to the client's employees may feature a similar section. The underwriter portal, meanwhile, may feature a section where the underwriter may view all of the questions and answers received by the service with respect to this particular client, and may feature a detailed security risk profile generated from these answers and any other available data. Other features may include, for example, an executive summary of the above report, a summary of the top 10 findings or the top 10 greatest risks identified, or a summary of the top findings in a particular area (for example, physical security). Other embodiments of the service may also include, for example, pages showing the status of a security inquiry (for example, this may include information about the number of questions answered by the client and the client's employees, or may include the status of another data collection effort) or pages showing the security status of a firm over time.

In an exemplary embodiment, the collection and organization of enterprise security data for objective evaluation may be configured for implementation on a tablet. In alternative exemplary embodiments, the collection and organization of enterprise security data for objective evaluation may be configured for implementation on a PC, mobile device, or other system as would be understood by a person having ordinary skill in the art. An exemplary tablet embodiment may be implemented such that the tablet device functions are limited to those necessary for the assessment and to ensure confidentiality of sensitive information. This may be implemented through software, hardware, and procedural measures. Exemplary hardware may include security hardware, such as GPS tracking hardware, biometric scanners, or other security hardware as would be understood by a person having ordinary skill in the art. Similarly, software may include known security software such as activity tracking software, remote access and erasing software, or software for restricting activity. Procedural measures may include device usage and handling policies set by the provider.

Each tablet may contain a single security domain or module, which may be used in an assessment. In some alternative embodiments, a tablet may have multiple security domains or modules. In an exemplary embodiment, an assessment may involve the evaluation of 6 security domains. In such an embodiment, there may be six proctors, or users, assigned and each proctor may be assigned one of the six domains. The proctor may subsequently have a tablet configured for the assessment of that domain. The proctor may collect answers to domain questions through the pre-screening surveys or interviews. The answers may be presented through the tablet or computer device to the proctor, or may be entered by the proctor. The responses may then be compared and confirmed through documentation review. The application may ensure comprehensive coverage of complex questions and may eliminate gaps in the multifaceted assessment methodology. The application may further reveal analysis and results of the assessment. For example, once an assessment is completed, data from the assessment may be communicated from the assessment device to an assessment server, which may process and analyze the data. The analysis may include creating threat vectors based on the data and returning the threat vectors in various formats, including graphical formats, for user interaction. The syncing of the assessment device to the assessment server may further reveal an aggregate score within each domain, which may reflect the controls in practice at the client site relative to the entire domain control list. The aggregate score for the domain may then be communicated back to the assessment device in soft copy through a secure portal. Overall analysis, including multiple domains, may also be communicated. Other analysis may be performed and returned, including, for example, highlighting priority risks or findings. These risks may be identified based on risk sensitivity determined from the analyzed data. The priority risks may be highlighted to a client in hard-copy or soft copy final reports and may include recommended remediations.

Referring to exemplary FIG. 5, a login page 500 may have a title 502 identifying it as a portal intended for a specific kind of user, in this case an underwriter. The URL 506 may also serve this purpose. The page may prompt the user for an email address and a password 504, and may have functionality to allow a user to be sent their password or to reset it should they forget it. According to another embodiment, the login page 500 may be a generic portal and may automatically redirect a user with valid login information to the appropriate page. According to a third embodiment, the page may feature a drop-down menu permitting the user to login to a portal of their choice.

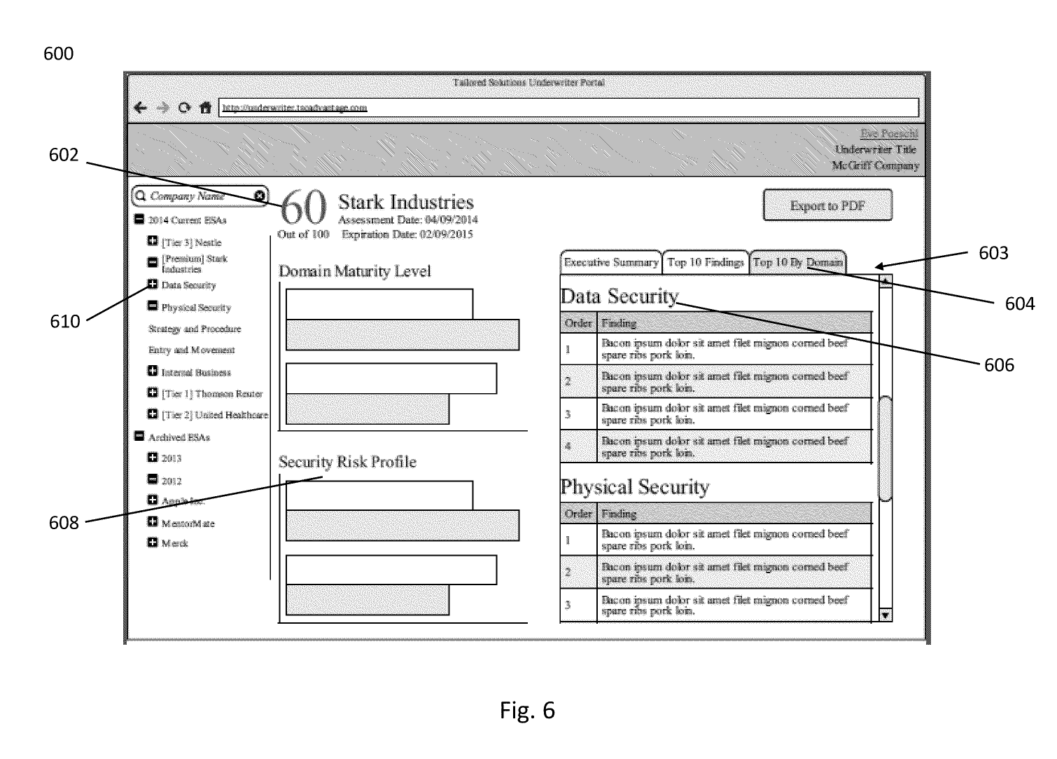

Referring to exemplary FIG. 6, once the user has logged in, they may be directed to a home page 600. Example home page 600 may feature a threat assessment level 602, threat assessment statistics 608, and a detailed threat summary 603. Threat assessment level 602 may be calculated from all other data, and may be used, for example, to track trends in security. Threat assessment level 602 may also have a date and expiration date associated with it; this may be used to indicate, for example, how often it is recommended that the client renew their security assessment and the next time it is recommended for them to request one. Security risk profile 608 may feature a more detailed breakdown of the statistical data used to generate the threat assessment level 602; for example, each bar may correspond to a particular domain of a result, such as “Data Security” or “Physical Security.” Different domains may have different levels; for example, a firm may be found to have comparatively good physical security but comparatively poor data security, or vice-versa. This may be used to provide a quick visual summary of what the firm is doing well or what it needs to improve on.

A more detailed breakdown of the threat levels in each domain may be available in the detailed threat summary 603. Detailed threat summary 603 may include multiple sections, represented here as tabs 604, that display different information or different presentations of information. In this instance, detailed threat summary 603 displays tabs 604 corresponding to an executive summary of the threat assessment report, a summary of the top 10 most notable security issues discovered, and a breakdown of those 10 security issues by the domain of the threat. The top 10 security issues in question may be calculated by, for example, how much influence the security issues had on generating the threat assessment level 602, or may be calculated by another means. The domain breakdown tab 604 may show short summaries of every security issue discovered, categorized by the domains 606 that the security issues were classified as falling into, for example those shown in FIG. 6.

Certain navigation options 610 may also be available to the user. For example, according to the embodiment of FIG. 6, the intended user is an underwriter who has been contracted by multiple different firms and who is using the same software to evaluate the security of each firm. The navigation options 610 may allow the user to navigate to different firms, different sections of each firm's threat assessment report, or elsewhere, as desired. For example, the user may choose from firms like “Stark Industries” or “United Healthcare,” and may view detailed reports in each domain. More detailed breakdowns than this may be available; for example, the user may be able to further navigate to pages dealing with the strategy and procedure of physical security (“Strategy & Procedure”) or the processes that security assessors were able to use to gain entry and move around the facility (“Entry & Movement”). Other pages may also be available, from the navigation bar 610 or elsewhere.

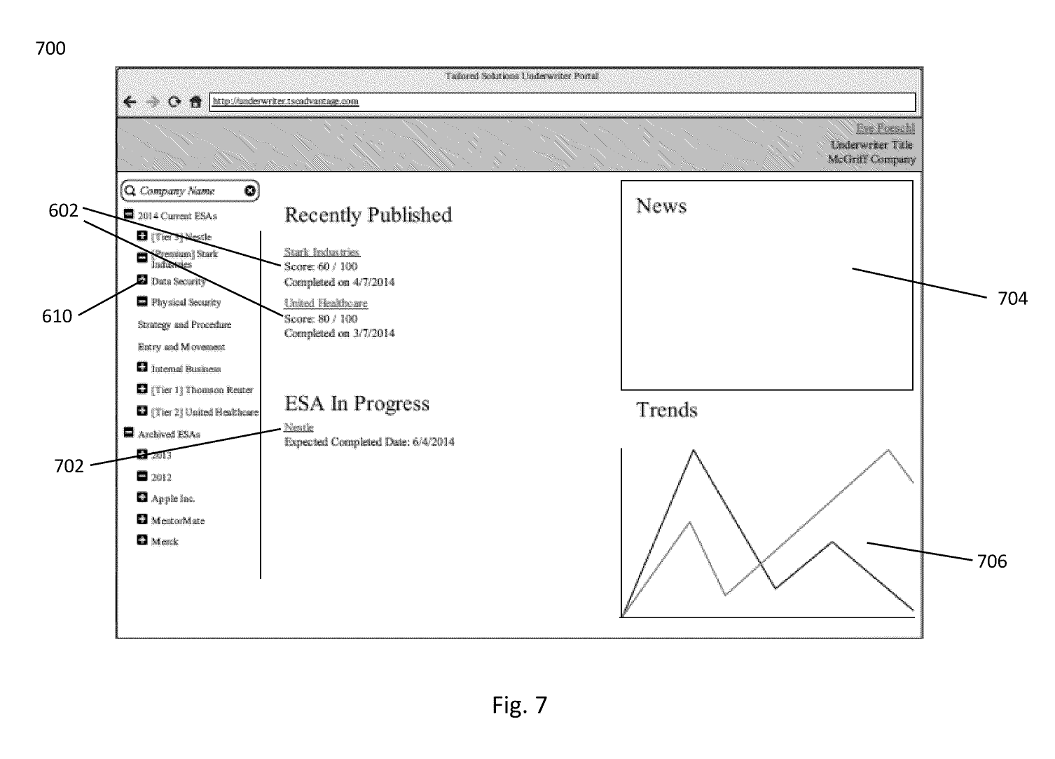

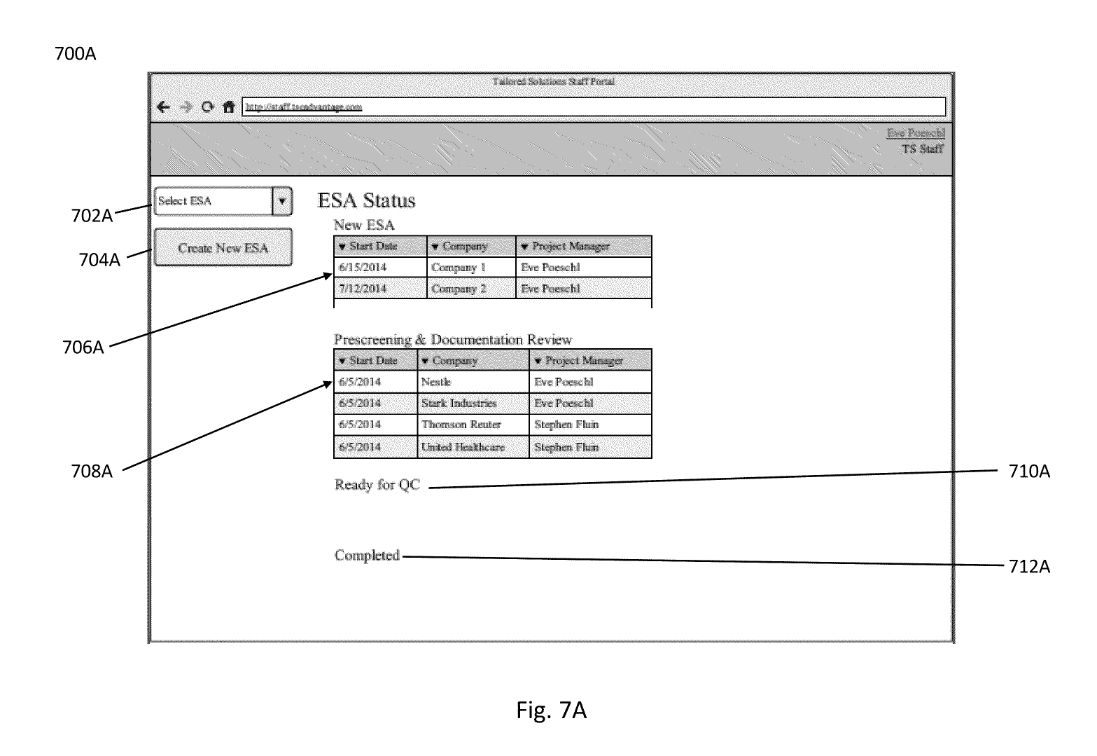

Referring to exemplary FIG. 7, an underwriter or another party with access to more than one company or pending threat assessment may have access to a dashboard page 700. The dashboard page may include threat assessment levels 602 for any and all firms that the user has access to, or any other applicable threat assessment levels 602. Firms with ongoing security assessments 702 may also be displayed, but may not have a threat assessment level 602 associated with them or may have some other indication that those results do not represent completed security assessments. Sections of the dashboard page may also display news 704 and broader trends 706; these may be, for example, news and trends for a specific firm, the security industry, for any or all of the industries that firms that are undergoing or that have undergone security assessments compete in, some combination of the above, or any other news or trends desired. The user may also be able to customize these displays. According to an exemplary embodiment, these sections may default to displaying news feeds and current trends about the computer security industry in order to assist a computer security-oriented user in staying current with the rest of the user's industry, but may be customized to show news feeds and current trends in another industry. This may assist a user in the process of generating a security assessment by, for example, enabling that user to come up with projections about possible corporate espionage attempts.

Referring to exemplary FIG. 7A, some parties may have access to a security assessment scheduling page 700A. Scheduling page 700A may function similarly to the dashboard page 700 in that it may provide an overview of all completed and pending security assessments that the user has access to view. However, either the scheduling page 700A or the dashboard page 700, should they exist concurrently, may contain information, options, or features that the other does not have; for example, the exemplary embodiment of a scheduling page shown in FIG. 7A provides a user with the options to select any security assessment available to them 702A, or to create an entirely new security assessment 704A, while the exemplary embodiment of a dashboard shown in FIG. 7 does not have either of these options.

Separate categories may be available for newly-created security assessments 706A, for security assessments that have advanced to either the prescreening stage or to the documentation stage 708A, for security assessments that are ready to be reviewed or to go through a quality control procedure 710A, and for security assessments that are considered to have been completed 712A. Security assessments filed under any of these categories may display date information, for example the date on which the security assessment was started, the date on which the security assessment was last updated, the date on which a security assessment was completed or the date on which a security assessment advanced to the next category. Timestamp information, such as the time at which any of the above events took place, may also be included. Security assessments filed under any of these categories may also include information about the customer; the firm or location at which the security assessment was requested, the sponsor of the security assessment, and any other details about the firm, location, or sponsor may all be displayed to the user. Security assessments filed under any of these categories may also include information about the staff assigned to the security assessments; this may include project managers, proctors, or persons otherwise designated to be in charge of the security assessments (as in FIG. 7A), any or all lower-level staff, and/or any outside parties that contributed to the security assessment. Security assessments displayed on this page may also include any other pertinent information, as desired. What information is displayed by each of these security assessments, as well as the categories themselves, may be adjustable by a user.

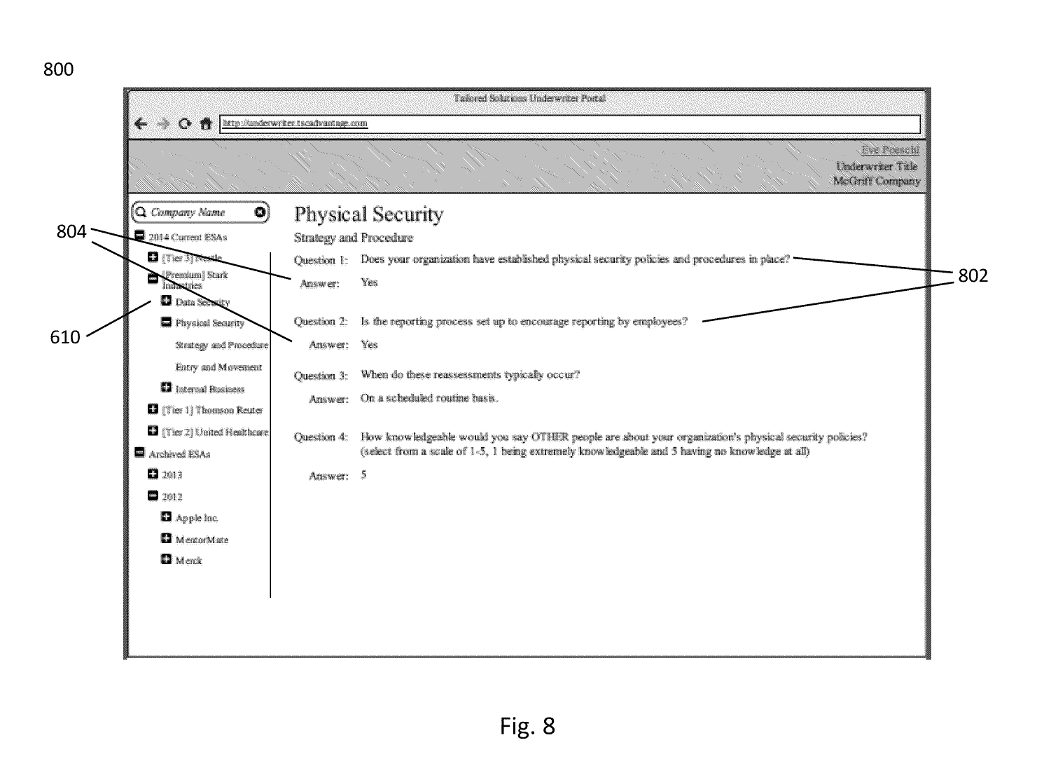

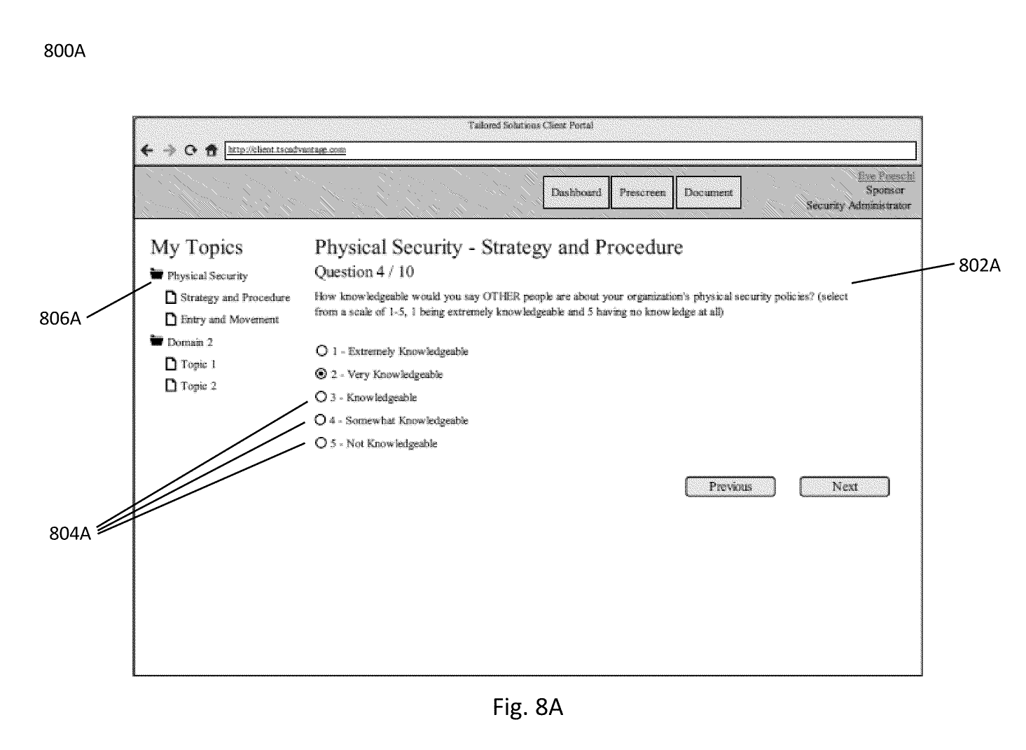

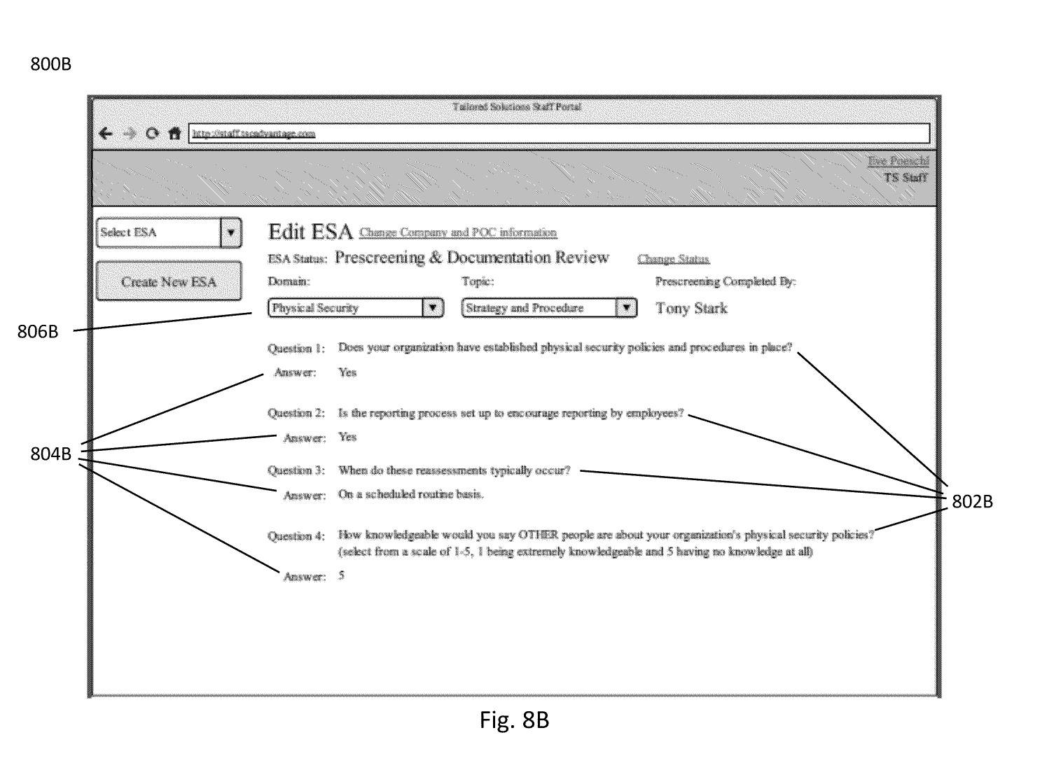

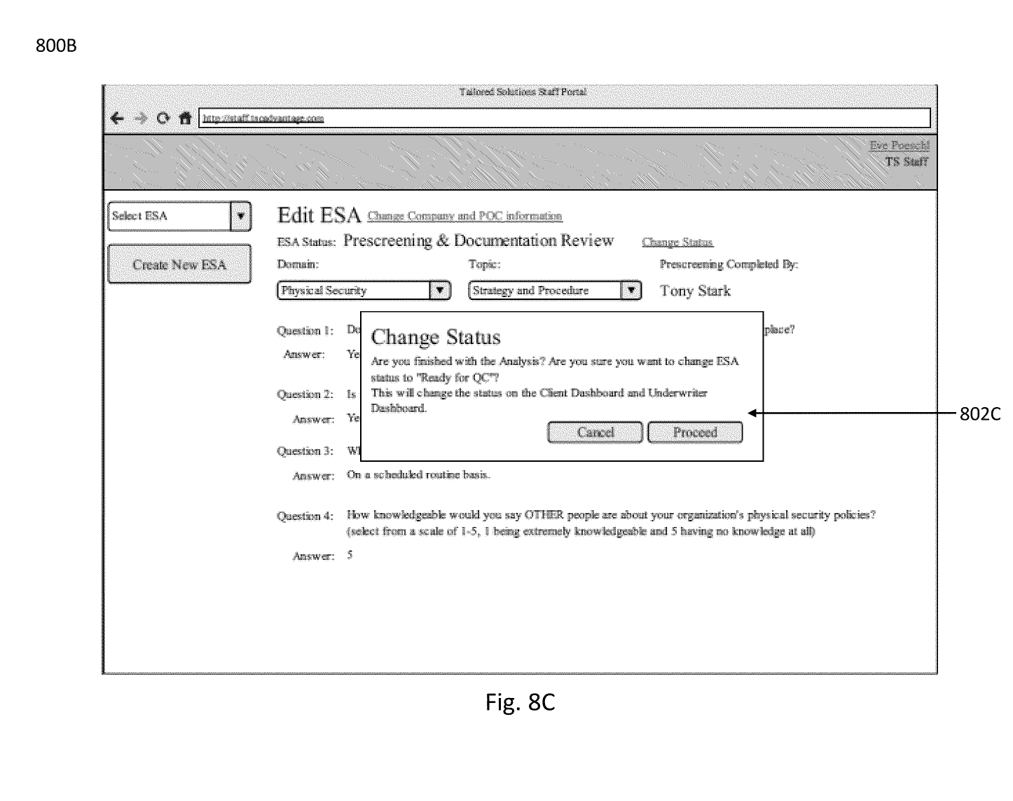

Referring to exemplary FIG. 8, a party may have access to a questions page 800. Questions page 800 may allow a user to answer a number of questions relating to security procedures and policy 802, or, depending on user privileges, may allow a user to view the answers 804 that others have provided. Questions may be in a binary format, for example requesting a “yes” or “no,” may be in a multiple-choice format, for example requesting a number between 1 and 5, or may be in any other format desired. According to the exemplary embodiment, sample questions may consist of an inquiry into whether the organization has clearly established physical security policies and procedures, whether the organization has a reporting process and whether the use of that reporting process by employees outside of the security department is encouraged, whether there are routine reassessments of any security policies and, if so, when they occur, and whether other employees are knowledgeable of and/or obey the physical security policies and procedures (assuming that they exist). Other questions may be provided as appropriate.

Referring to exemplary FIG. 8A, an alternative embodiment of a questions page 800A may be provided. Such an embodiment may be provided to users with lesser levels of authority or administrative privilege, or may exist alongside the questions page 800 shown in the previous figure. Questions page 800A may allow users to answer a number of questions relating to security procedures and policy 802A, and may allow them to select from multiple pre-provided answers 804A, may allow them to fill in their own answers in all cases or in select cases, and may allow them to skip questions entirely. Questions page 800A may also be tailored to particular users; for example, certain users may only be given question sets directed at certain topics 806A, or question sets may be tailored to the users themselves. A user that is a physical security professional for a client firm, for example, may be given questions pertaining to “physical security” and more specifically “strategy and procedure” and “entry and movement.” A user that is a data security professional for the client firm may be given an entirely separate set of questions pertaining instead to data security. A user that is a manager in the security department may be given both “physical security” and “data security” questions, but may be limited to only answering “strategy and procedure” questions in each category.

Referring to exemplary FIG. 8B, an alternative embodiment of a questions page 800B may be provided. The questions page 800B as provided in FIG. 8B may be restricted to a particular set of users, and may offer additional functionality on top of the questions pages described in the above exemplary embodiments. Questions page 800B may feature some or all of the available questions 802B available to be asked to users using the Web service, and may likewise show some or all of the available answers 804B that such users have provided in the course of the security assessment process. More answers than those shown may be provided; for example, the questions page 800B may show the most common answer provided by employees or other parties during the course of the security assessment, may show all answers provided by those parties, may show a detailed statistical breakdown of how many such parties have answered a particular question and how many answered with which answers, or may present the answers in any other desirable fashion.

Users of the questions page 800B may be able to control which questions are displayed and how they are displayed through the use of drop-down menu 806B, through another menu, or as desired. According to the exemplary embodiment shown in FIG. 8B, drop-down menu 806B may be used to filter questions by domain (for example, “Physical Security” or “Data Security”), by subdomain (for example, “Strategy and Procedure”), or by other criteria, such as by the party that answered the question, by the number of times the question has been answered, or by the influence the question has on the final calculation of risk. A user of the questions page 800B may also be able to edit an ongoing security assessment from this page; for example, they may be able to click on a hyperlink to launch an editor in a pop-up menu. Alternatively, they may be able to link from the questions page to another page where they may edit an ongoing security assessment.

As shown in exemplary FIG. 8C, users may also be able to advance or otherwise edit the status of the ongoing security assessment; for example, they may be able to advance a security assessment from the status of “Prescreening and Documentation Review” to the status of “Ready for QC.” The questions page 800B may launch a pop-up 802C in order to allow the user to confirm whether or not they want to make a particular edit, such as whether they want to advance the status of a security assessment or whether they want to change any other available information. This may include, for example, changing the company information associated with an ongoing security assessment, or changing the stored point-of-contact information.

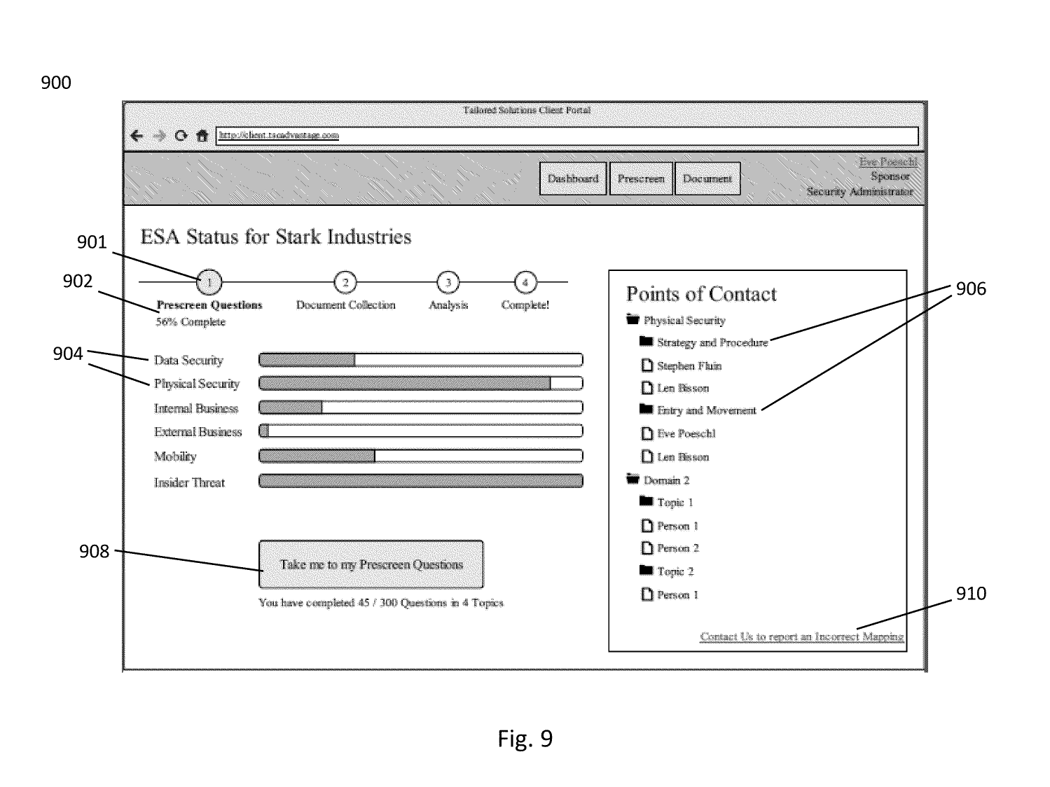

Referring to exemplary FIG. 9, a user may have access to a security assessment status page 900. Status page 900 may include, for example, a timeline of an ongoing security assessment 901, an indication of a client firm's progress in answering any prescreening questions 902, an indication of the estimated status of any component of the security assessment 904 (such as a data security analysis or an insider threat analysis), the consultants that have been tasked with performing each component part of the security analysis and the contact information for each 906, and a dialog to allow a user to be directed to the questions page 908. Indications 902, 904 may be a graphical display, a numerical figure, or otherwise, as desired. Status page 900 may also include an error report prompt 910, which may allow a user to report an incorrect mapping of a point-of contact 906, may allow a user to report another error in the point-of-contact tree or elsewhere on the Web service, or may allow a user to communicate with the Web service administrators or with any staff involved in the security assessment process, as desired.

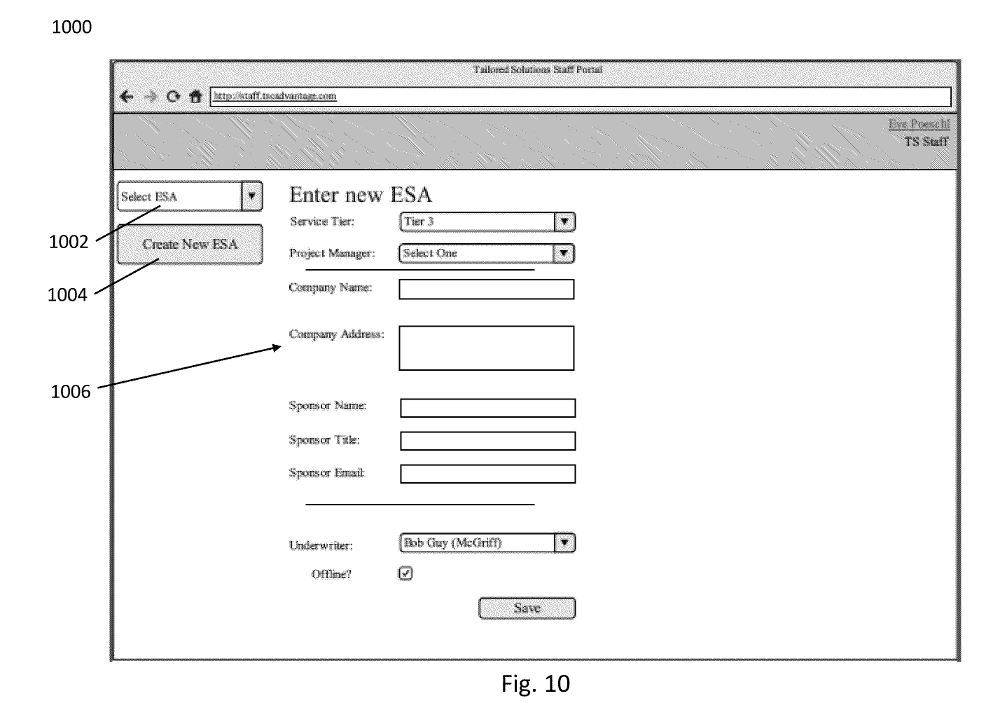

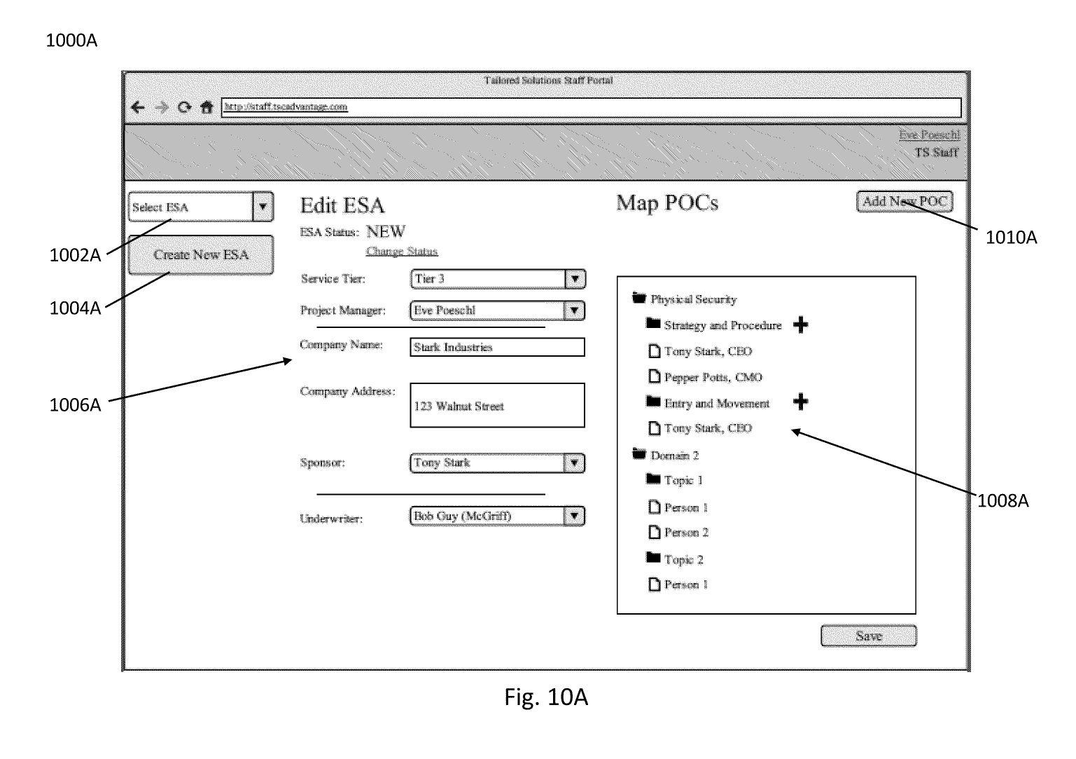

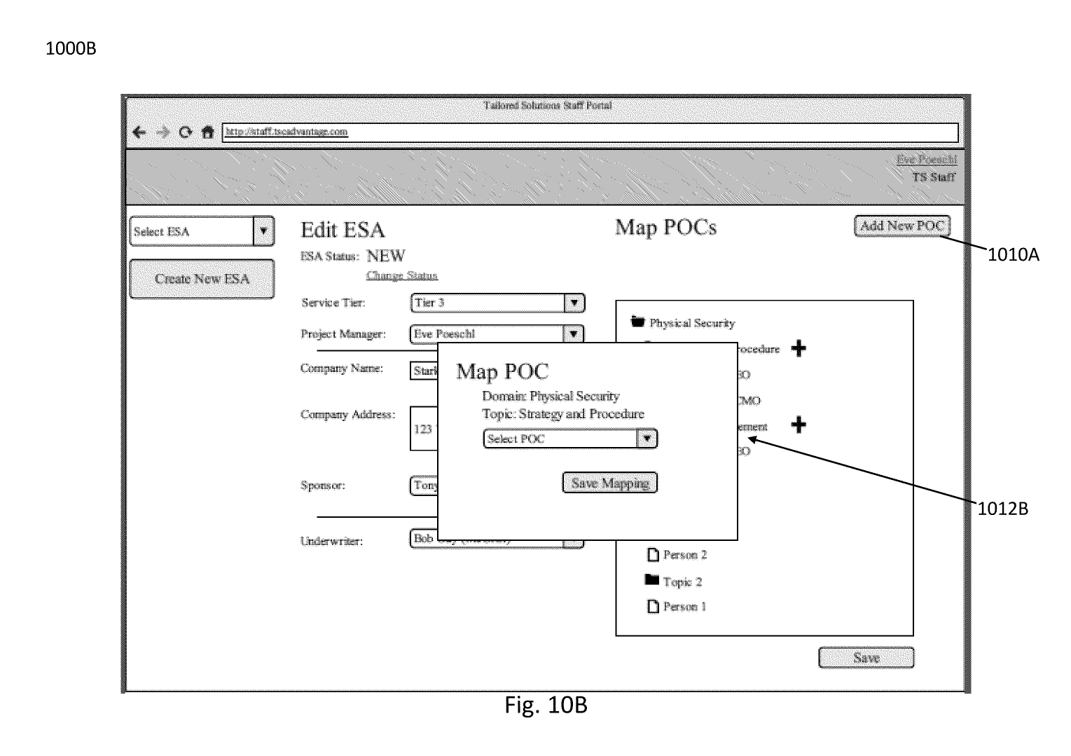

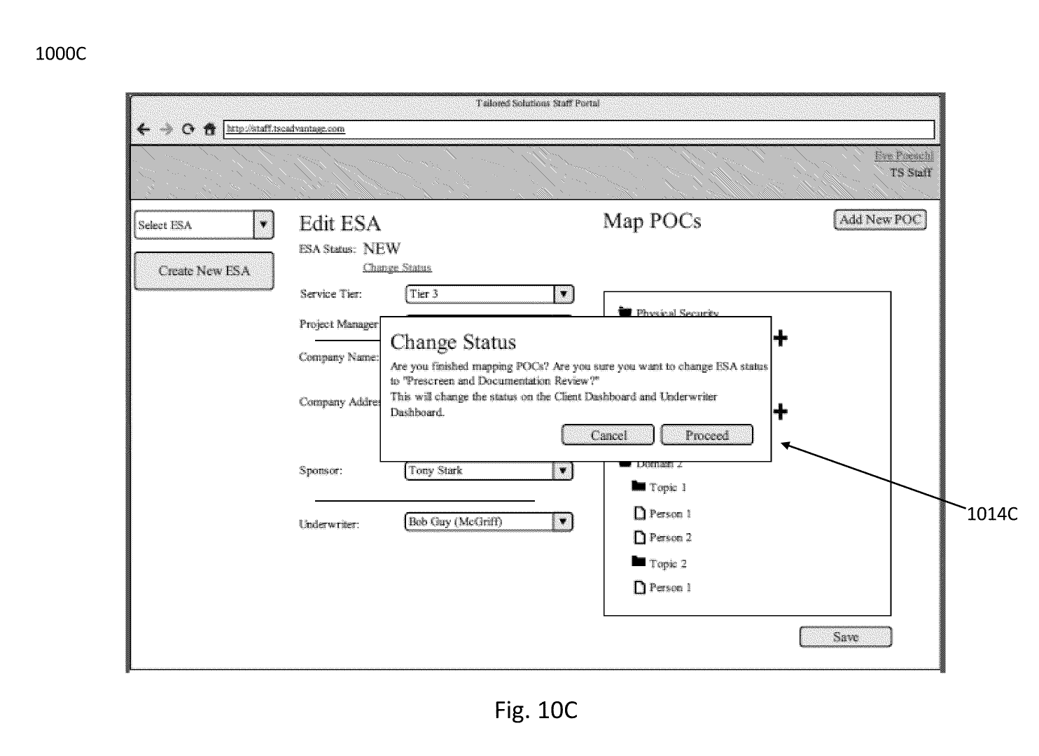

Referring to exemplary FIG. 10, a user may have access to an administrative page 1000; this page may allow a user to add a new security assessment to the program or may allow them to edit an existing one. Access to this page may be limited, for example to users with advanced administrative access, staff of a firm conducting the assessment, upper-level consultants, or as desired. The page may include a dialog to allow a user to select an existing security assessment that has been entered into the program 1002 or may allow them to create a new security assessment 1004; the latter option may be available if no previously-created security assessment is selected, or as desired. If the user opts to create a new security assessment by using the appropriate dialog 1004, a blank new security assessment form 1006 may be created; this may allow the user to input and save information like the service tier or priority of the security assessment, the proctors, project managers, underwriters, and/or other staff associated with the security assessment, the name and address of the firm to be assessed, and the name and contact information of a sponsor of the security assessment or a point of contact for the firm. If the user elects to edit an existing security assessment, the information previously provided for the firm or customer associated with the existing security assessment may be presented in a dialog similar to 1006; the user may then be able to modify and save that information, as desired. Records may be available of all edits made to existing security assessments to ensure that any edit may be reviewed and to ensure that any unauthorized edit may be modified or blocked.

Referring to exemplary FIG. 10A, a different embodiment of an administrative page 1000A may be available to a user that elects to edit an existing security assessment. As in the previous embodiment, a dialog to allow the user to select an existing security assessment 1002A or to create a new security assessment 1004A may both be present. A user selecting the former option to edit an existing security assessment may cause additional data to be displayed on the page as compared to the previous embodiment 1000; for example, the security assessment form appearing in the previous embodiment 1000 may be automatically filled with the relevant existing information concerning the security assessment in question. According to such an embodiment, the user may be able to edit the security assessment in question by editing the pre-filled new security assessment form 1006A and then subsequently saving the new information, which may cause the old information to be archived or overwritten. Sponsor information may be saved as a part of an existing, pending, or previous security assessment, or may be stored separately; for example, the pre-filled new security assessment form 1006A shows a drop-down arrow next to the category of “Sponsor” and omits the options to enter a sponsor's name, title, email address, or other pertinent information about the sponsor into the form 1006A. Sponsor records may be saved elsewhere in the software, and a user may be able to select previously-used sponsor information and add it to a new security assessment form 1006A without requiring the user to reenter all information about that sponsor; this may save the user time, and ensure that sponsor information remains consistent if the same sponsor requests more than one security assessment.

Information about persons assigned to or otherwise of relevance to a security assessment may also be made available on the administrative page 1000A. For example, the exemplary embodiment shown in FIG. 10A shows a list of all parties currently participating in the security assessment 1008A, the parties' job titles or relation to the assessing party, and the security-related tasks to which the parties have been assigned; alternative embodiments of this display 1008A may show the contact information of the parties, the current progress of each of the parties at their assigned tasks, the current progress within each of the domains or subdomains being tested (for example, “Physical Security” or “Strategy and Procedure”), or any other information desired. This display 1008A may also allow additional parties to be assigned to each domain component of the security assessment; according to the exemplary embodiment of FIG. 10A, additional parties may be assigned to either the “Strategy and Procedure” subdomain or to the “Entry and Movement” subdomain, for example by the user selecting the “plus” symbol located next to each subdomain folder or by the user selecting an “Add New Point of Contact” button 1010A. Parties may also be removed from a domain component of the security assessment, for example by selecting the party's name and subsequently selecting an option to remove the party in question.

Referring to exemplary FIG. 10B, the user may be prompted to add a new point of contact to a particular domain or subdomain by a pop-up window 1012B; this may be prompted by the user selecting the “plus” symbol located next to each subdomain folder, by the user selecting an “Add New Point of Contact” button 1010A, automatically after the user fulfills some condition (for example, if the user tries to exit without adding any points of contact to a new security assessment), or otherwise, as desired. The pop-up window 1012B may allow the user to select from previously-entered points of contact, may allow the user to input new information about a new point of contact, may allow the user to edit previously-entered points of contact similar to the new security assessment form of FIG. 10A, or as desired. The user may also be able to input, edit, or save this data without the use of a pop-up window; for example, instead of the user interface generating a pop-up window, the user may be redirected to a Web form into which they may input the point of contact's information.

Referring to exemplary FIG. 10C, a user may be provided with a confirmation dialog after performing an action. For example, a user may be provided with the following pop-up window 1014C if a number of points of contact have been assigned and if the user attempts to exit the page; the pop-up window may prompt the user to confirm whether or not they wish to cease editing the current security assessment, save the current point-of-contact configuration, and/or change the status of the current security assessment to “Prescreen and Documentation Review.” The user may be able to confirm the information they have entered by selecting an affirmative option on the pop-up window, for example “Proceed,” or may be able to resume editing the current security assessment by selecting a negative option, for example “Cancel.” Other alternative options may also be available. The confirmation dialog may also be provided by means other than a pop-up window; for example, the user may be redirected to a page where they may see all of their pending changes and may then be prompted to save those changes and go to another page, or may be provided this dialog by another method.

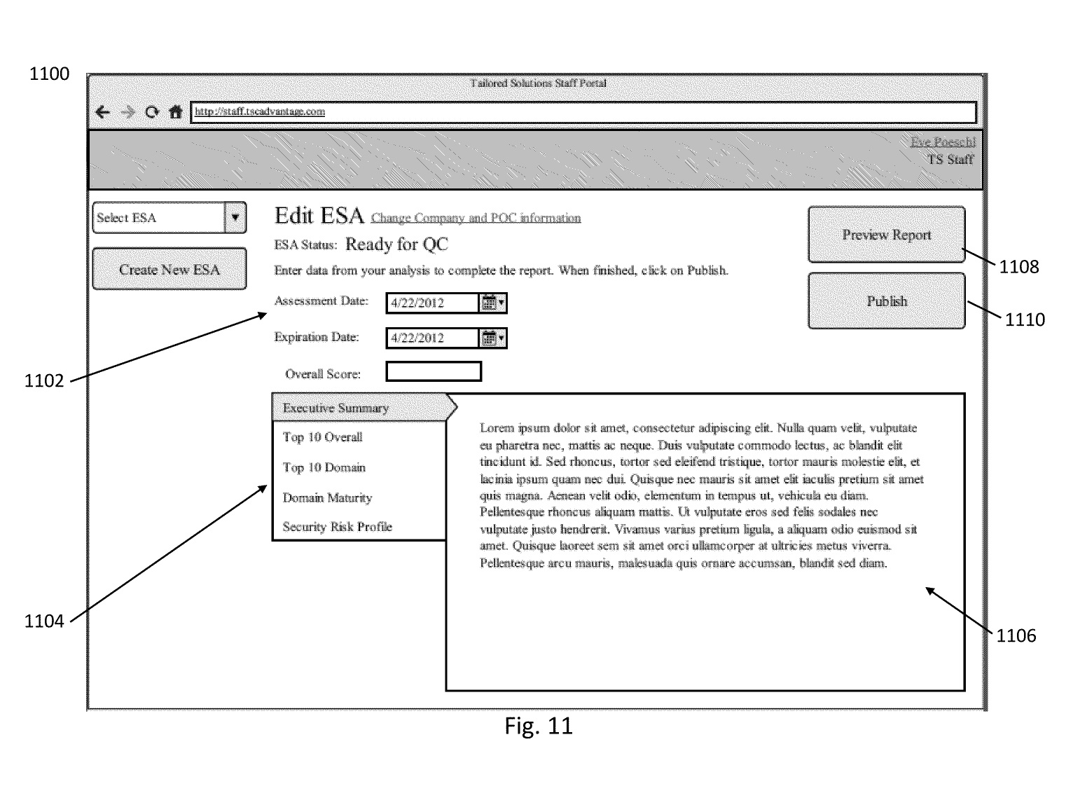

Now referring to exemplary FIG. 11, a user may have access to a publication screen 1100. Publication screen 1100 may allow a user to report the results of a security assessment, generally when that security assessment has been substantially completed. A user may be able to input or edit pertinent information about the security assessment into a series of input boxes 1102; this information may include whether the security assessment was passed, the score that the assessee received, the date on which the security assessment took place, the date on which the security assessment is set to expire, or any other desired information. Users may also be able to report information about the security assessment in more detail; for example, users may use the publication screen 1100 to generate any of an executive summary of the final security assessment report, a list of the top 10 security risks overall, a list of the top 10 security risks by domain, an evaluation of the assessee's domain maturity, or an evaluation of the assessee's security risk profile 1104. Other options, or variations of the above options, may also be available; for example, a user may be able to input the top 20 security risks instead of the top 10.

Users may be able to generate the above reports in a variety of ways, for example by manually composing them into an input field 1106 or by using the software to generate them automatically from uploaded information. For example, if an overall score is generated by an algorithm that evaluates the security score of the assessee, the software may be able to identify the ten largest contributions to that security score and identify the specific security risk data associated with those contributions. Users may be able to preview their reports, for example to verify that all information is correct or to verify formatting, via a “Preview Report” function 1108, and may be able to publish their reports via a “Publish” function 1110. Other such functions may also be employed, as desired. The results may further be communicated in hard or soft copy, such as through a secure portal accessed on the assessment device or a client device.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for data gathering and security assessment, implemented on a computer system, this method comprising:
submitting question data to a client;
receiving client answer data;
receiving documentation review data;
aggregating the client answer data and the documentation review data;
authenticating a user;
displaying the aggregated client answer data and documentation review data to the user;
receiving input from a user;
syncing the aggregated client answer data, documentation review data, and user input with an assessment server for analysis; and
communicating the analysis results to the assessment device.

2. The method of claim 1, further comprising comparing the aggregated client answer data and documentation review data with at least one cyber security standard.

3. The method of claim 1, further comprising analyzing the aggregated client answer data and documentation review data, generating a list of the most significant sources of risk, and displaying that list to one of: the user and the client.

4. The method of claim 1, further comprising generating a security score and displaying the security score to one of: the user and the client.

5. The method of claim 1, further comprising generating a domain maturity level and displaying the domain maturity level to one of: the user or the client.

6. The method of claim 1, further comprising generating a security risk profile and displaying the security risk profile to one of: the user or the client.

7. The method of claim 1, further comprising communicating the aggregated client answer data, the documentation review data, and the user input are communicated to a client computer system.

8. The method of claim 1, wherein the aggregated client answer data, the documentation review data, and the user input are communicated to a printer device.

9. A system for data gathering and security assessment, this system comprising:
at least one assessment device configured to aggregate client answer data and documentation data, allow a user to access and interact with the data, and communicate the data; and
an assessment server configured to receive data from the at least one assessment device, analyze the data, and return analysis data to at least one of the assessment device and a client computer device.

10. The system of claim 7, wherein the analysis data is communicated to a printer device.

11. The system of claim 7, wherein the aggregated client answer data and documentation review data are compared with at least one cyber security standard, and wherein the result of the comparison is displayed on a graphical user interface.

12. The system of claim 7, wherein the assessment server is configured to analyze the aggregated client answer data, documentation review data, and user input data, generate a list of the most significant sources of risk, and displays that list on a graphical user interface.

13. The system of claim 7, wherein the assessment server is configured to generate and communicate a security score.

14. The system of claim 7, wherein the assessment server is configured to generate and communicate a domain maturity level.

15. The system of claim 7, wherein the assessment server is configured to generate and communicate a security risk profile.

16. An apparatus for managing data gathering and security assessment data, this apparatus comprising:
a display screen;
a user input interface;
a networking unit;
a processor; and
a memory operationally linked to the processor, the memory comprising executable instructions that when executed by the processor cause the processor to effectuate operations comprising:
communicating question data from an assessor computer system to a client computer system via the networking unit;
receiving client answer data;
receiving documentation review data;
aggregating the client answer data and the documentation review data;
displaying the aggregated client answer data and documentation review data on the display screen;
receiving input from a user via the user input interface;
syncing the aggregated client answer data, documentation review data, and user input with an assessment server for analysis; and
receiving the analysis data.

17. The apparatus of claim 16, wherein the assessment server is configured to aggregate the client answer data, documentation review data, and user input data, generate a list of the most significant sources of risk, and communicate the list.

18. The apparatus of claim 16, wherein the memory additionally comprises instructions for receiving news and trend information and displaying that information on a graphical user interface.

19. The apparatus of claim 16, wherein the assessment server is configured to analyze the aggregated client answer data, documentation review data, and user input data, evaluate the aggregated data against a knowledge-base of cyber security standards, and communicate the analysis data.
